(19) United States
(12) Patent Application Publication
(10) Pub. No.: US 2010/0213017 A1
(43) Pub. Date: Aug. 26, 2010

(54) WHEEL-TYPE RESISTANCE DEVICE FOR AN EXERCISER

(76) Inventor: Chung-Ping Cheng, Yunlin Hsien (CN)

Correspondence Address: FISH & RICHARDSON PC, P.O. BOX 1022, MINNEAPOLIS, MN, 55440-1022, US

(21) Appl. No.: 12/390,733

(22) Filed: Feb. 23, 2009

(51) Int. Cl. H02K 49/10

(52) U.S. Cl. 188/164

(57) ABSTRACT

A wheel-type resistance device includes a flywheel rotatably mounted on a shaft, a mount secured to the shaft and having a slot, left and right mounting strips anchored to the mount and having pulled ends adjacent to the slot, left and right pulling cords respectively connected to the pulled ends and respectively having left and right lugged ends, a guiding block operable to move along the slot such that a hauling force is transmitted for lugging the lugged ends to thereby move the mounting strips, and a force apportioning member coupling the lugged ends with the guiding block such that during movement of the guiding block, a main amount of the hauling force is initially diverted to the left pulling cord to move the left mounting strip, and the hauling force transmitted to the left and right lugged ends is subsequently equalized to move the left and right mounting strips.

### BACKGROUND OF THE INVENTION

1. Field of the Invention

This invention relates to a wheel-type resistance device for an exerciser, more particularly to a wheel-type resistance device for providing variable resisting forces to an exerciser.

2. Description of the Related Art

Referring to FIGS. 1 and 2, a conventional magnetic adjustable loading device 1 for an exerciser disclosed in U.S. Pat. No. 5,711,404 is shown to include a flywheel 11 rotatably mounted on a shaft 13, a metal conductor 111 attached to an inner peripheral wall of the flywheel 11, two disks 14 secured on the shaft 13 and cooperating with the metal conductor 111 to define an annular space, two magnetic plates 15 disposed in the annular space, and an adjusting unit 16.

Specifically, the disks 14 respectively have radially extending guiding slots 141 communicated with each other and each having outer and inner ends 142,143. Each magnetic plate 15 has a pivot end 151 pivotally mounted on the disks 14, a moving end 152 opposite to the pivot end 151, and a plurality of permanent magnets 153 disposed between the pivot and moving ends 151,152. The adjusting unit 16 includes a guiding rod 161 slidably disposed in the guiding slots 141, two pulling cords 162 connecting the moving ends 152 and the guiding rod 161, and an operating member 163 disposed to be externally operable so as to move the guiding rod 161. The adjusting unit 16 is externally operable to move between a normal position, where the guiding rod 161 is in the outer end 142 and the magnetic plates 15 are close to the metal conductor 111 so as to generate a large resistance against rotation of the flywheel 11, and a straining position, as shown in FIG. 3, where the guiding rod 161 is in the inner end 143 such that the pulling cords 162 are tensely lugged to thereby pull the moving ends 151,152 away from the metal conductor 111 so as to generate a small resistance.

However, operation of the operating member 163 may cause the guiding rod 162 to move the pulling cords 162 together so that the resistance may vary to a considerable extent, which renders precise resistance adjustment difficult.

### SUMMARY OF THE INVENTION

An object of the present invention is to provide a wheel-type resistance device which permits precise adjustment of a resisting force applied to an exerciser.

According to this invention, the wheel-type resistance device includes a flywheel mounted on a shaft to be rotatable about a shaft axis, and having an inner peripheral wall which is provided with a magnetically attractive layer. A mount is secured to the shaft, and includes left and right wall segments which angularly extend from left and right initial ends to terminate at left and right terminal ends, respectively. The left and right terminal ends are spaced apart from each other to define a slot. The slot extends towards the shaft to define a guideway. The left and right wall segments are spaced apart from the magnetically attractive layer. Left and right mounting strips respectively have left and right anchored ends anchored adjacent to the left and right initial ends, respectively, and respectively extend along the left and right wall segments to terminate at left and right pulled ends that are proximate to the left and right terminal ends, respectively. Left and right pulling cords respectively extend from the left and right pulled ends to terminate at left and right lugged ends, respectively. The left and right lugged ends are luggable towards the shaft so as to displace the left and right mounting strips from a normal position to a strained position. Left and right magnetically attracting members are respectively disposed on the left and right mounting strips, and confront the magnetically attractive layer so as to generate a large resistance against rotation of the flywheel in the normal position, and a small resistance in the strained position. A guiding block is disposed to be externally operable, and is movable along the guideway between non-adjusted and adjusted positions. The guiding block has a seat surface such that, when the guiding block is moved from the non-adjusted position to the adjusted position, a hauling force that increases in increments is transmitted by the seat surface for lugging the left and right lugged ends towards the shaft. A force apportioning member is disposed to couple the left and right lugged ends with the seat surface so as to enable the left and right mounting strips to displace from the normal position to the strained position when the guiding block is moved from the non-adjusted position to the adjusted position such that, when the guiding block is moved from the non-adjusted position to the adjusted position, a major amount of hauling force increments is diverted from the seat surface to the left pulling cord, and the diverted amount of the hauling force increments is gradually reduced so as to equalize amounts of the hauling force increments transmitted to the left and right lugged ends once the guiding block reaches the adjusted position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a conventional wheel-type resistance device for an exerciser;

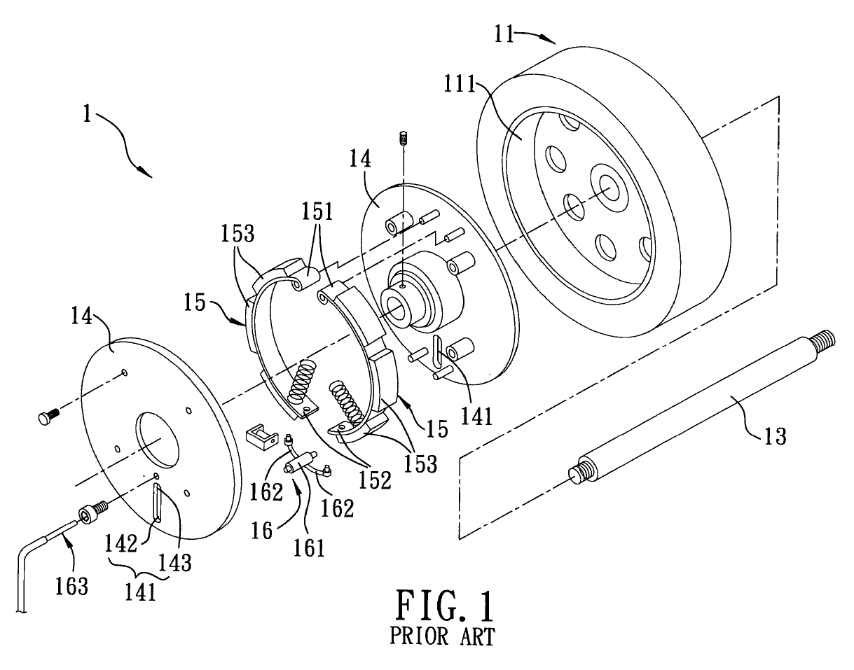

FIG. 2 is a sectional view of the conventional wheel-type resistance device before adjustment;

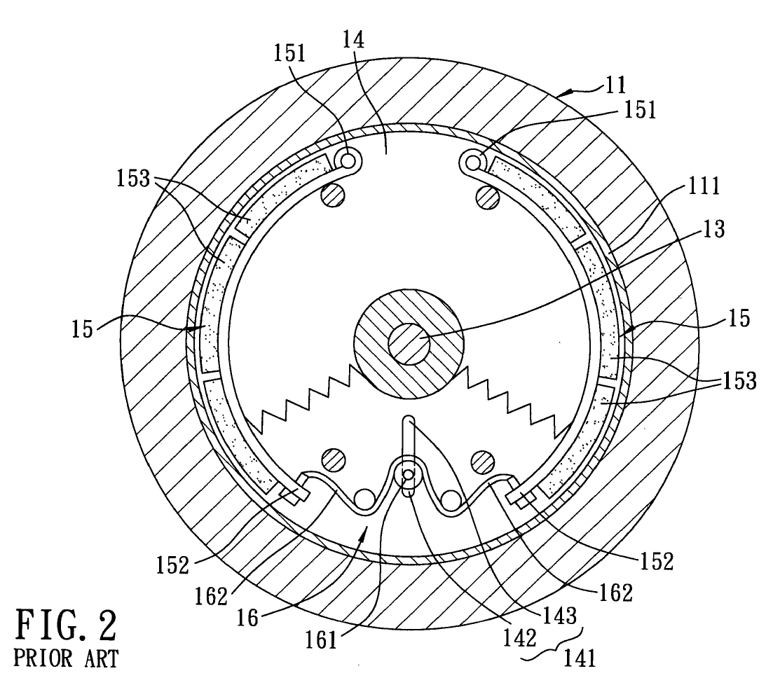

FIG. 3 is a sectional view of the conventional wheel-type resistance device after adjustment;

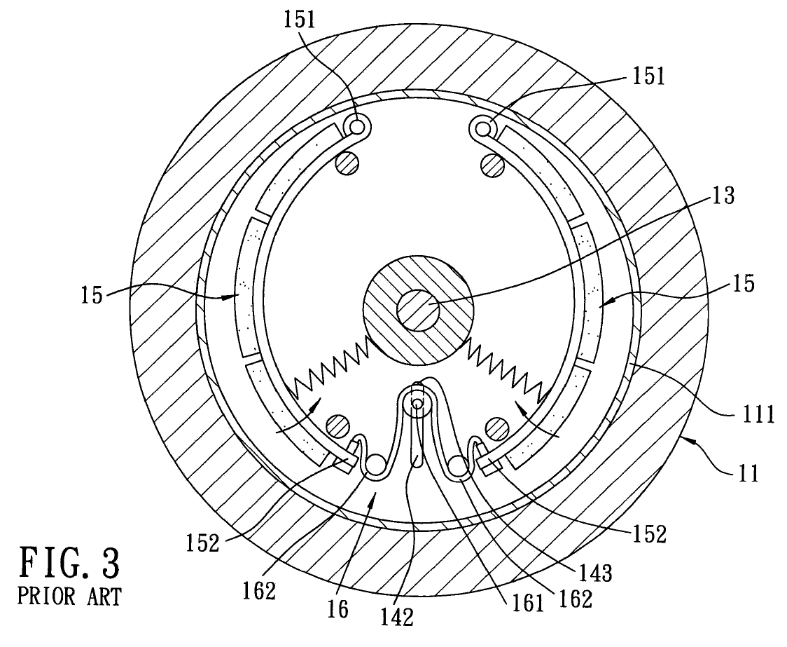

FIG. 4 is an exploded perspective view of the preferred embodiment of a wheel-type resistance device for an exerciser according to this invention;

FIG. 5 is a sectional view of the preferred embodiment when a guiding block is in a non-adjusted position;

FIG. 6 is a sectional view similar to FIG. 5, showing the guiding block in a middle position; and

FIG. 7 is a sectional view similar to FIG. 5, showing the guiding block in an adjusted position.

### DETAILED DESCRIPTION OF THE PREFERRED EMBODIMENT

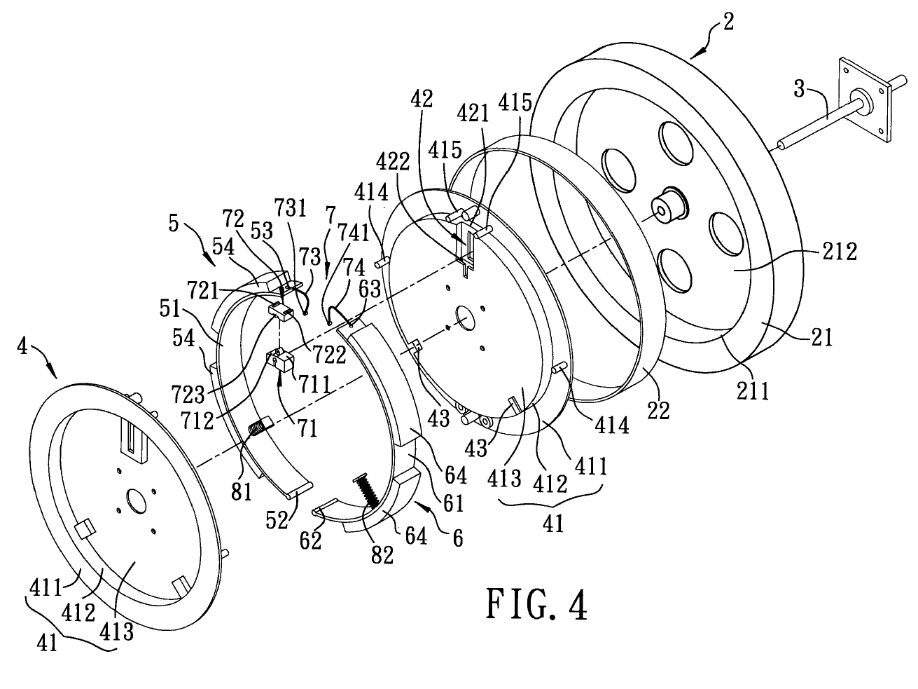

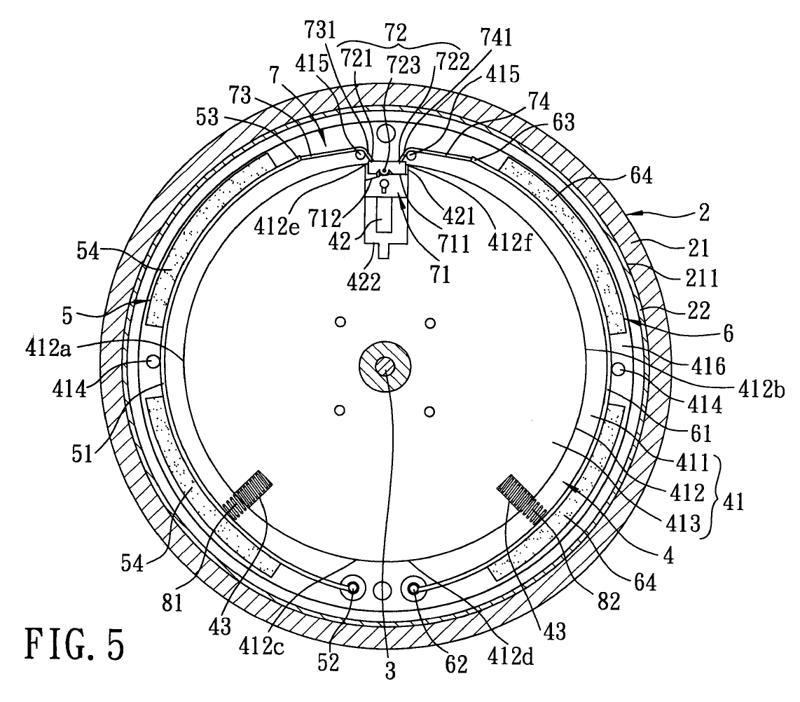

Referring to FIGS. 4 and 5, the preferred embodiment of a wheel-type resistance device according to the present invention is shown to comprise a shaft 3 which is adapted to be mounted on a frame of an exerciser (not shown) and which extends along a shaft axis, a flywheel unit 2, a mount 4, left and right magnetic resistance units 5,6, left and right biasing members 81,82, and a control unit 7.

The flywheel unit 2 includes a flywheel 21 which is mounted on the shaft 3 to be rotatable about the shaft axis, and which has an inner peripheral wall 211 surrounding and confronting the shaft 3 to define an accommodation space 212 therein, and a magnetically attractive layer 22 which is disposed on the inner peripheral wall 211 and which is made from a metal material with magnetic conductivity.

The mount 4 is disposed in the accommodation space 212, and is secured to the shaft 3. The mount 4 includes plastic front and rear shells 41 which respectively have front and rear base walls 413 that are disposed normal to the shaft 3 and that abut against each other, front and rear rims 412 that extend axially and respectively from the front and rear base walls 413 and that surround the shaft axis to cooperatively define left and right wall segments (412a,412b), and front and rear flanges 411 that extend radially and outwardly from the front and rear rims 412, respectively. The left and right wall segments (412a,412b) extend respectively and angularly extend from left and right initial ends (412c,412d) about the shaft axis, and terminate respectively at left and right terminal ends (412e,412f). The left and right terminal ends (412e,412f) are spaced apart from each other to define a slot 42 which extends towards the shaft 3 to define a guideway. The left and right wall segments 412 are spaced apart from the magnetically attractive layer 22 such that an annular space 416 is defined among the front and rear flanges 411 and the front and rear rims 412. Further, left and right guiding members 415 are disposed on each of the front and rear flanges 411 of the mount 4 adjacent to the left and right terminal ends (412e,412f), respectively. The left and right guiding members 415 may be posts or pulleys rotatably mounted on the mount 4.

The left and right magnetic resistance units 5,6 are received in the annular space 416. The left magnetic resistance unit 5 includes a left mounting strip 51 and a left magnetically attractive member 54. The right magnetic resistance unit 6 includes a right mounting strip 61 and a right magnetically attractive member 64.

The left and right mounting strips 51,61 respectively have left and right anchored ends 52,62 which are pivotably mounted on the front and rear flanges 411 adjacent to the left and right initial ends (412c,412d), respectively. The left and right mounting strips 51,61 respectively extend along the left and right wall segments (412a,412b), and respectively terminate at left and right pulled ends 53,63 which are proximate to the left and right terminal ends (412e,412f), respectively.

The left and right magnetically attracting members 54,64 are respectively disposed on the left and right mounting strips 51,61, and confront the magnetically attractive layer 22. Each of the left and right magnetically attracting members 54,64 includes a plurality of permanent magnets 54,64.

The left and right biasing members 81,82 are respectively disposed in left and right grooves 43 that extend radially and that are formed in the front and rear base walls 413 so as to respectively bias the left and right mounting strips 51,61 toward the magnetically attractive layer 22.

Further, left and right limiting posts 414 extend axially from each of the front and rear flanges 411 so as to guard against excess movement of the left and right mounting strips 51,61 when biased by the biasing members 81,82, thereby preventing the left and right magnetically attracting members 54,64 from undesirably contacting the magnetically attractive layer 22.

The control unit 7 includes left and right pulling cords 73,74, a guiding block 71, and a force apportioning member 72.

The left and right pulling cords 73,74 respectively extend from the left and right pulled ends 53,63 to terminate at left and right lugged ends 731,741, respectively. The guiding block 71 is disposed to be externally operable, and is movable along the slot 42 between a non-adjusted position 421, where the guiding block 71 is remote from the shaft 3, and an adjusted position 422, where the guiding block 71 is close to the shaft 3. The guiding block 71 has a seat surface which faces away from the shaft 3 and which includes slant and flat segments 712,711. The force apportioning member 72 has left and right connected ends 721,722 which are disposed opposite to each other relative to a centerline of the slot 42 and which are respectively connected to the left and right lugged ends 731,741, and a fulcrum 723 which is pivotably mounted on the seat surface about a pivoting axis that intersects the centerline. The left lugged end 731 is distant from the fulcrum 723 by a first length that is smaller than a second length between the right lugged end 741 and the fulcrum 723.

As shown in FIG. 5, when the guiding block 71 is in the non-adjusted position 421, the slant segment 712 is spaced apart from the left connected end 721, the flat segment 711 abuts against the right connected end 722, and the left and right mounting strips 51,61 are placed in a normal position, where each of the left and right mounting strips 51,61 is radially remote from a corresponding one of the left and right wall segments (412a,412b). Thus, a large magnetic resistance is generated against rotation of the flywheel 21.

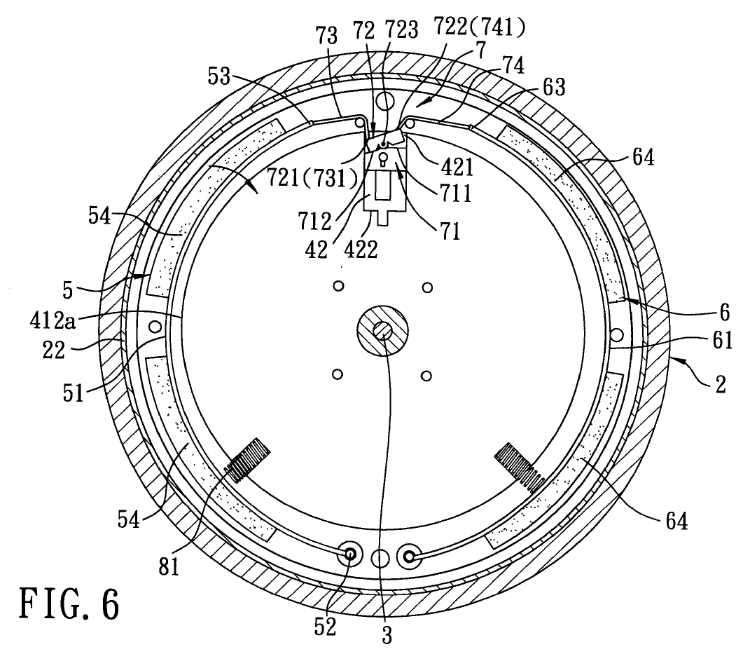

During resistance adjustment, when the guiding block 71 is advanced from the non-adjusted position 421 toward the adjusted position 422, as shown in FIG. 6, the left connected end 721 is initially turned, so that a major amount of a hauling force that increases in increments is transmitted by the slant segment 712 to haul the left lugged end 731 so as to lug the left lugged end 731 towards the shaft 3 and displace the left mounting strip 51 to a strained position, where the left mounting strip 51 is radially close to the left wall segment (412a). Thus, the magnetic resistance is slightly reduced. At this time, the right mounting strip 61 is maintained in the normal position, the left connected end 721 abuts against the slant segment 712, and the right connected end 722 is disengaged from the flat segment 711.

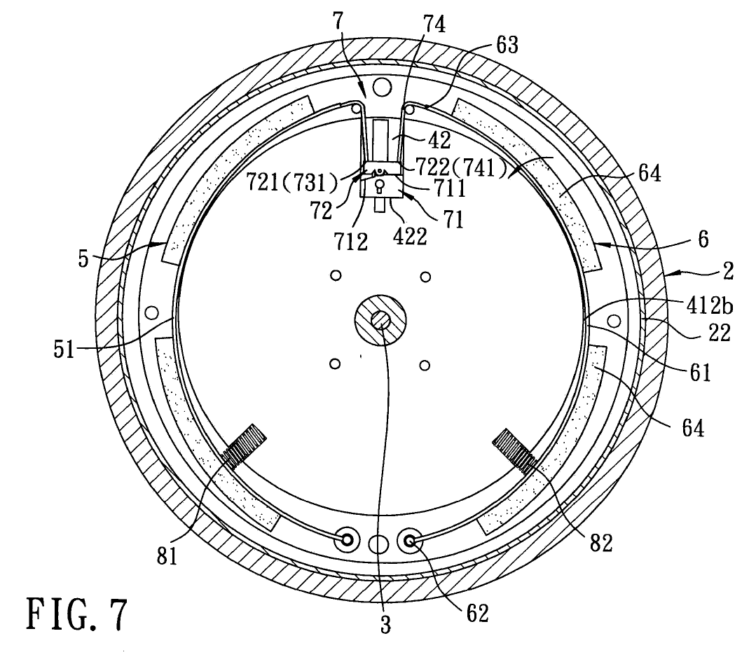

Subsequently, when the guiding block 71 is further advanced to the adjusted position 422, as shown in FIG. 7, the diverted amount of hauling force increments is gradually reduced so as to equalize amounts of the hauling force increments transmitted to the left and right lugged ends 731,741 once the guiding block 71 reaches the adjusted position, thereby lugging the right lugged end 741 towards the shaft 3 and displacing the right mounting strip 61 to a strained position, where the right mounting strip 61 is radially close to the right wall segment (412b). Thus, the magnetic resistance is further reduced. At this time, the right connected end 722 abuts against the flat segment 711 while the left connected end 721 is disengaged from the slant segment 712.

Through the cooperation of the seat surface with the force apportioning member 72, when the guiding block 71 is moved from the non-adjusted position 421 to the adjusted position 422, a clearance between the magnetically attractive layer 22 and the left magnetically attractive member 54, and a clearance between the magnetically attractive layer 22 and the right magnetically attractive unit 64 can be gradually reduced so that the magnitude of the magnetic resistance can be gradually and precisely adjusted. In this embodiment, the clearances may have a maximum size of 9 mm.

Further, the left and right guiding members 415 can guide the left and right pulling cords 73,74 to facilitate the lugging movement of the left and right lugged ends 731,741 towards the shaft 3.

As illustrated, by virtue of the force apportioning member 72 which is pivotally mounted on the guiding block 71 and which has two unequal arms of force, during resistance adjustment, the left magnetic resistance unit 5 is initially displaced toward the shaft 3, and the right magnetic resistance unit 6 is then displaced toward the shaft 3. Therefore, precise and fine adjustment can be achieved.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A wheel-type resistance device for providing a resisting force to an exerciser, comprising:
a shaft adapted to be mounted on a frame of the exerciser and extending along a shaft axis;
a flywheel mounted on said shaft to be rotatable about the shaft axis, and having an inner peripheral wall which surrounds and confronts said shaft and which defines an accommodation space therein;
a magnetically attractive layer disposed on said inner peripheral wall;
a mount disposed in said accommodation space and secured to said shaft, said mount including left and right wall segments which respectively and angularly extend from left and right initial ends about the shaft axis and which respectively terminate at left and right terminal ends, said left and right terminal ends being spaced apart from each other to define a slot which extends towards said shaft to define a guideway, said left and right wall segments being spaced apart from said magnetically attractive layer;
left and right mounting strips which respectively have left and right anchored ends that are anchored adjacent to said left and right initial ends, respectively, said left and right mounting strips respectively extending along said left and right wall segments, and respectively terminating at left and right pulled ends that are proximate to said left and right terminal ends, respectively;
left and right pulling cords respectively extending from said left and right pulled ends to respectively terminate at left and right lugged ends, said left and right lugged ends being luggable towards said shaft so as to displace said left and right mounting strips from a normal position, where each of said left and right mounting strips is radially remote from a corresponding one of said left and right wall segments, to a strained position, where each of said left and right mounting strips is radially close to the corresponding one of said left and right wall segments;
left and right magnetically attracting members respectively disposed on said left and right mounting strips, and confronting said magnetically attractive layer so as to generate a large resistance against rotation of said flywheel in the normal position, and a small resistance in the strained position;
a guiding block which is disposed to be externally operable, and which is movable along said guideway between a non-adjusted position, where said guiding block is remote from said shaft, and an adjusted positions, where said guiding block is close to said shaft, said guiding block having a seat surface which faces away from said shaft such that, when said guiding block is moved from the non-adjusted position to the adjusted position, a hauling force that increases in increments is transmitted by said seat surface for lugging said left and right lugged ends towards said shaft; and
a force apportioning member which is disposed to couple said left and right lugged ends with said seat surface so as to enable said left and right mounting strips to displace from the normal position to the strained position when said guiding block advances from the non-adjusted position to the adjusted position, said force apportioning member being configured such that, when said guiding block is moved from the non-adjusted position to the adjusted position, a major amount of the hauling force increments is initially diverted from said seat surface to said left pulling cord, and the diverted amount of the hauling force increments is reduced gradually so as to equalize amounts of the hauling force increments transmitted to said left and right lugged ends once said guiding block reaches the adjusted position.

2. The wheel-type resistance device according to claim 1, wherein said guideway defines a centerline extending towards said shaft, said force apportioning member has left and right connected ends which are disposed opposite to each other relative to said centerline, and which are connected respectively to said left and right lugged ends, and a fulcrum which is pivotably mounted on said seat surface about a pivoting axis that intersects the centerline.

3. The wheel-type resistance device according to claim 2, wherein said left lugged end is distant from said fulcrum by a first length that is smaller than a second length between said right lugged end and said fulcrum such that, when said guiding block is moved from the non-adjusted position to the adjusted position, said left connected end is initially turned so as to divert a major amount of the hauling force increments for hauling said left lugged end to thereby displace said left mounting strip to the strained position, and said right connected end is turned so as to equalize the amounts of the hauling force increments transmitted to said left and right lugged ends for hauling said left and right lugged ends to thereby displace said right mounting strip to the strained position.

4. The wheel-type resistance device according to claim 3, wherein said seat surface of said guiding block includes a slant segment which is spaced apart from said left connected end in the non-adjusted position, and a flat segment which is disposed to abut against said right connected end in the non-adjusted position such that, when said guiding block is moved from the non-adjusted position to the adjusted position, said left connected end is initially permitted to be turned so as to abut against said slant segment and cause said right connected end to disengage from said flat segment, and said right connected end is pivoted to abut against said flat segment once said guiding block reaches the adjusted position.

5. The wheel-type resistance device according to claim 1, wherein said left and right anchored ends are pivotably mounted on said mount, said resistance device further comprising left and right biasing members which are disposed to respectively bias said left and right mounting strips toward said magnetically attractive layer.

6. The wheel-type resistance device according to claim 5, wherein said mount includes front and rear shells which respectively have front and rear base walls that are disposed normal to said shaft and that abut against each other, front and rear rims that extend respectively and axially from said front and rear base walls and that surround the shaft axis to cooperatively define said left and right wall segments, and front and rear flanges that respectively extend radially and outwardly from said front and rear rims such that an annular space is defined among said front and rear flanges and said front and rear rims for accommodating said left and right mounting strips.

7. The wheel-type resistance device according to claim 6, wherein each of said front and rear shells has left and right limiting posts which extend axially from a respective one of said front and rear flanges so as to guard against excess movement of said left and right mounting strips, thereby preventing said left and right magnetically attracting members from undesirably contacting said magnetically attractive layer.

8. The wheel-type resistance device according to claim 1, further comprising left and right guiding members which are disposed on said mount adjacent to said left and right terminal ends, respectively, to guide said left and right pulling cords, and which are configured to facilitate lugging movement of said left and right lugged ends towards said shaft.

9. The wheel-type resistance device according to claim 8, wherein said guiding members are pulleys rotatably mounted on said mount.

10. The wheel-type resistance device according to claim 1, wherein each of said left and right magnetically attracting members includes a plurality of permanent magnets, and said magnetically attractive layer is made from a metal material.
